(19) United States
(12) Patent Application Publication
(10) Pub. No.: US 2008/0259795 A1
(43) Pub. Date: Oct. 23, 2008

(54) Automatic Connectivity Adaptation of Packet Traffic in a Transport Network

(76) Inventors: Giovanni Fiaschi, Genova (IT); Piergiorgio Sessarego, Genova (IT)

Correspondence Address: COATS & BENNETT, PLLC, 1400 Crescent Green, Suite 300, Cary, NC, 27518, US

(21) Appl. No.: 12/090,652

(22) PCT Filed: Oct. 18, 2006
(86) PCT No.: PCT/EP2006/010036

§ 371 Date: May 13, 2008

(30) Foreign Application Priority Data
Oct. 18, 2005 (IT) MI2005 A001972
Oct. 18, 2006 (EP) PCT/EP2006/010036

(51) Int. Cl. H04L 12/26; H04J 3/16; H04L 12/56

(52) U.S. Cl. 370/232; 370/468; 370/352

(57) ABSTRACT

A method for automatic adaptation of connectivity by means of virtual concatenation groups of packet traffic in a circuit switched transport network in which an estimate of the packet traffic is made and the band available between packet interfaces which engage the transport network is increased or decreased by creation or removal of virtual concatenation circuits according to the necessities indicated by the estimate.

This invention relates to a method for automatic adaptation of connectivity for packet traffic transport network.

Packet switched networks, and Internet Protocol networks in particular, are capable of (and, hence, make this their strong point) dealing efficiently rapidly changing traffic needs. Indeed, these network not allocate bandwidth in advance and handle each ur traffic (packet) separately so that each packet will only the bandwidth strictly necessary.

This flexibility is not free since packet switch routers have a complexity that clearly exceeds other flexible technologies. For example, an SDH/SONET (SDH=Synchronous Digital Hierarchy, SONET=Synchronous Optical Network) cross-connect is recognized as being cost effective for equal throughput capability the router. An SDH/SONET system is also more scalable the packet switching.

A good telecommunications network should be made a balance of transport and switching equipment. A ne with much routing capacity would be flexible but c while a network with more transport capacity would be cost effective but would have a worse performance subjected to highly dynamic traffic demands.

Large packet networks and in particular Internet are made up of a number of packet switched routers and a transport network for connecting them with each other. In the prior art the transport network is conventionally assumed to be very slow in connectivity changes so that all the network adaptations to traffic demands are expected only from the routers.

However, together with growing presence of large IP routers in the backbone networks there is still a large installed base of SDH/SONET transport equipment. The spread of a technology is already a benefit in itself. Furthermore, the transport technologies also have some advantages over the connectionless packet technologies used in the IP routers. For example, Time Division Multiplexing (TDM) transmission is faster, guarantees delays and latencies and is more cost effective since it avoids analysis of the individual data packets. In addition, SDH technology is the most ‘carrier class’ product among those available today due to the fact that it possesses a well-proven standardized set of techniques for the operation and maintenance and protection of the traffic.

Being a circuit-oriented technology, SDH is not directly ready to offer the typical Internet service where a user does not express bandwidth requirements in advance. For this type of service, the capability of allocating bandwidth on a packet basis makes the IP routers superior. Instead, in SDH an explicit circuit set up is required but this assumes a knowledge of the previous bandwidth required.

One way of improving the above-mentioned scenario and combining the advantages of both technologies would be to add a dynamic response to the transport network. Recently, standardization bodies like the ITU, OIF and IETF have proposed solutions like Automatic Switched Transport Network (ASTN) and Generalized Multi-Protocol Label Switching (GMPLS) which introduce flexibility in the establishment of circuits. This approach, however, needs a complex real time traffic estimation on the routers to translate the traffic needs into explicit connectivity requests to the transport network.

The general purpose of this invention is to remedy the above mentioned shortcomings by making available a traffic measurement capability directly within the SDH/SONET and/or Optical Transport Network (OTN) to automatically command bandwidth adaptations by means of circuit switching without disturbing the routers that are interconnected by the transport network.

In view of this purpose it was sought to provide in accordance with this invention a method for automatic adaptation of packet traffic connectivity by using a circuit switched transport network in which there is made a packet traffic estimate and the bandwidth available between packet interfaces engaging the transport network is increased or decreased according to the need indicated by the estimation, creation or removal of circuits with virtual concatenation.

Advantageously the packet interface functions are set between LAN and circuit switched network, framing and mapping functions, virtual concatenation functions and an automatic control plan which upon reception of requests from a traffic estimator commands capability adjustment functions by means of the virtual concatenation functions.

Preferably, the traffic estimation is done on the basis of a traffic measurement. Alternatively, the traffic estimation is done on the basis of advance estimated bandwidth necessity requests for packet traffic.

Preferably, the control plane is an ASTN function. Moreover, the capability adjustment function is an LCAS function, the virtual concatenation function is a VCAT function and the framing and mapping functions are a GFP function.

Alternatively, the framing and mapping functions can comprise a POS function with PPP/HDLC.

The method of the present invention finds particular application in a transport network which is of the SDH type, SONET type or OTN (ITU-T-G.709) type.

According to a second aspect of the invention there is provided a network with packet traffic and comprising routers and/or switches interconnected by a circuit switched transport network using a method in accordance with the invention.

To clarify the explanation of the innovative principles of this invention and its advantages compared with the prior art there is described below with the aid of the annexed drawings a possible embodiment thereof by way of non-limiting example applying said principles. In the drawings:

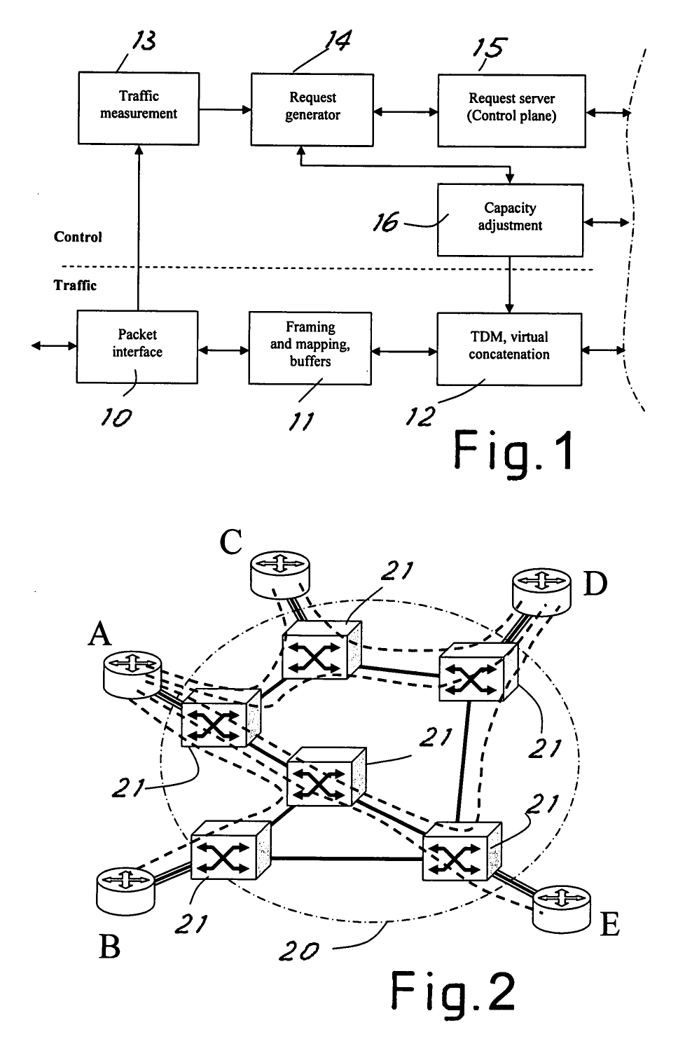

FIG. 1 shows a block diagram of the set of functions that in accordance with this invention are included in the packet interfaces for the Time Division Multiplexing (TDM) transport equipment,

FIG. 2 shows a diagrammatic example of connection between routers by virtual concatenation over a circuit switched network, and

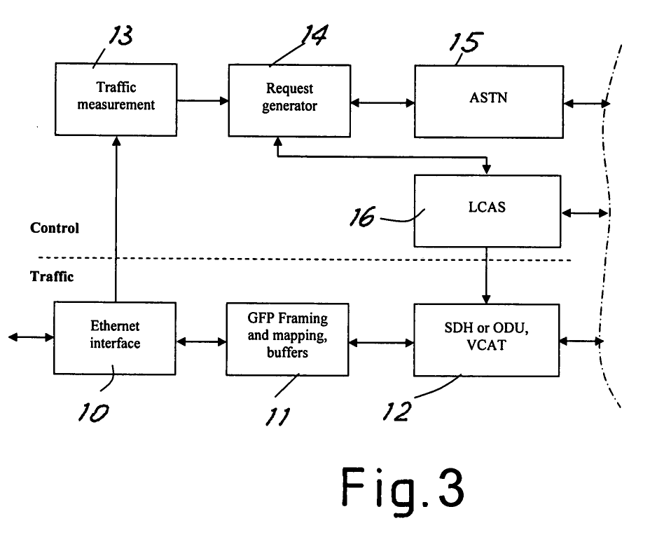

FIG. 3 shows a diagram similar to that of FIG. 1 but representing an example of application.

With reference to the figures, FIG. 1 shows a block diagram of functions realizing the method in accordance with this invention. The set of functions can be divided into traffic and control parts.

The traffic functions comprise a packet interface 10 capable of packet switching, a frame mapping function 11, the known standard TDM functions of the transport node and virtual concatenation capability 12. The control part comprises a traffic measurement function 13, a circuit set up/tear down request generator 14, an automatic circuit set up/tear down function 15 belonging to the network control plane, a dynamic adaptation function 16 for modifying the virtual concatenation to include or remove capabilities without service interruption.

The request generator 14 receives from the traffic estimator 13 n bits of information on the quantity of traffic necessary and issues the requests for layout or unconcatenation of a circuit on the basis of crossing a predetermined threshold of measured traffic.

In one realization, the traffic estimator 13 can be a traffic measurer that detects traffic input to the interface. In addition or as an alternative, the traffic estimator 13 estimates on the basis of traffic request signaling arriving from the LANs (Local Area Networks). This, for example, could be the case when the network has to satisfy service quality levels predetermined with the customers who then send their traffic necessity request.

For the present invention it is assumed that the circuit network does not need information about the addresses of the circuit endpoints since the invention concerns itself only with increases and decreases of bandwidth for circuits already established as virtual concatenation groups.

During operation, first a circuit with minimal capacity is set up between two packet capable interfaces. If two IP routers are connected to the two ends of the circuit they automatically discover the surroundings. Normally, these routers do not use information concerning the link capacity.

If the traffic between the two interfaces increases, the traffic measurement function 13 detects the amount. The exact definition of the traffic measurement function is not important here since it is for example easily derivable from traffic conditioning functions already available and generally used for policy reasons (‘token bucket’). The measurement function is therefore in itself easily imaginable to those skilled in the art.

Traffic is advantageously measured on a relationship basis. This means that if on a single packet interface it is possible to distinguish between several packet flows to be mapped on transport circuits for different destinations, each flow requires its own traffic measurement data.

The detected traffic value is sent to the request generator 14. The request generator possesses established thresholds with which the measured traffic is compared.

If a predetermined traffic increase threshold is exceeded, a circuit-set up request is generated and, if there is bandwidth available in the network, a new circuit is set up between the two interfaces. Then the new circuit is included in the virtual concatenation group which, by the interface towards the network, behaves like a single circuit and the bandwidth between the two interfaces is in this manner increased by one unit.

In the same way, if the traffic decreases, the traffic measurement unit 13 communicates its value to the request generator 14. If a threshold is crossed, a circuit is removed from the virtual concatenation group forming the link between the two interfaces, then a request for circuit tear-down is generated and the circuit is released.

It is clear how correct configuration of the thresholds depends largely on the real capability of the individual physical circuits that can be used to form the virtual concatenation. The thresholds should allow for the capability of the real circuits that can be called to form (in case of bandwidth increase) or form (in case of bandwidth decrease) the virtual concatenation group.

FIG. 2 shows an example of routers connected in accordance with the principles of this invention over a circuit switched network designated as a whole by reference number 20. The routers are designated by A, B, C, D, and E.

In the example application, this invention is applied to a network of IP routers connected over an SDH backbone. The SDH cross-connects of the network 20 are designated by 21.

Since the individual adjacencies between two routers has initially a low capability, it is possible to establish a high degree of meshing between the routers. High meshing between the routers has the advantage of avoiding traffic on the transit routers while limiting the amount of costly equipment with packet switching capability.

The routers are connected from the SDH equipment over a LAN interface to any other adjacent router. For example, if router A is to be made adjacent to B, C, D and E, it needs at least four LAN interfaces to allow the routing protocols to work correctly. A virtual LAN is possible for a more cost effective solution. The circuits set up on the physical lines (solid lines) are designated in broken lines in FIG. 2.

The capacity of the LAN interfaces must be high enough to allow for peak traffic. Therefore, if a virtually concatenated circuit is set up between routers A and B, and this can vary from 140 Mbps to 10 Gbps, routers A and B must be connected to the SDH network with a 10 Gbs interface.

As described in the present example, the routers are connected to the SDH cross-connects over appropriate Ethernet interfaces. Router A will have direct adjacencies with B, C, D and E. The relationships will be realized immediately and created with low capacity at the beginning of the life of the network so that even many configured relationships can be had and this will not require allocation of too much bandwidth. Each router requires an interface to identify its direct connection with the adjacent router; to save physical interfaces, it is possible to use VLANs (Virtual Local Area Networks). In the example, router A will have configured four VLANs on one physical Ethernet. During operation of the network, the measured traffic on the Ethernets will involve, the set up or tear-down of circuits composing the virtual concatenation to dynamically increase or decrease the bandwidth associated with each relationship. In the example, the AD relationship is widened to allocate band on two different paths. It is the responsibility of automatic control plane (for example ASTN) to seek available bandwidth in the most economical manner. In this manner, assuming that not all relationships require the maximum of the bandwidth simultaneously, it is possible to utilize the network resources more efficiently than with an SDH support with fixed location.

The system in accordance with this invention converts the packet capability requests (measured directly or otherwise estimated) and converts them into appropriate circuit requests if there are not already circuits able to satisfy them and/or inserts packets into the circuits already active but not completely used. For example, if circuits are necessary to satisfy packet traffic requests for 180 Mb and each circuit can carry at the most traffic for 140 Mb, two linked circuits will be activated. The 100 Mb remaining free can by used later to satisfy another packet traffic, possibly together with new circuits.

As shown in FIG. 3, in the application example the interface 10 will be an Ethernet interface, the mapping and framing 11 will comprise a known Generic Framing Procedure (GFP) and the virtual concatenation system 12 of the network can advantageously be the Virtual Concatenation (VCAT) proposed for the SDH or ODU networks. The request server 15 for the automatic control plane will be an Automatic Switched Transport Network (ASTN) and the capacity adjustment function 16 can be based on the recent known Link Capacity Adjustment Scheme (LCAS) standard. Therewith, it is possible to command bandwidth adaptations by means of circuit switching while avoiding any disturbance of the traffic by utilizing the LCAS standard. In the example, the estimator 13 is a traffic measurer.

The transport network can even be the SONET or OTN (ITU-T-G.709) type. For the framing and mapping functions the known Packet over SONET (POS), with Point-to-Point Protocol/High-level Data Link Control (PPP/HDLC) can be used.

The complexity that must be added to the network to implement the functions called for by this invention is limited and confined to the edges of the transport network, which still maintains the natural economy of the transport network while all the modifications are transparent for the router network which does not require any change.

By adding capabilities to automatically and dynamically adapt the connectivity to the measured traffic needs, a transport network can become an economically advantageous alternative at least in those parts of the network where the changes in traffic are not too abrupt. This allows reduction of the capability of the router network since the new transport network can perform part of the work more effectively. This also opens up the possibility of using transport equipment not only as packet switched router meshing but to directly connect other customers since the new transport network is capable of independent connectivity location.

Naturally the above description of an embodiment applying the innovative principles of this invention is given by way of non-limiting example of said principles within the scope of the exclusive right claimed here.

1-13. (canceled)

14. A method of automatically adapting packet traffic connectivity using a circuit switched transport network, the method comprising:
estimating an amount of packet data traffic; and
based on the estimation, creating or removing virtual concatenation circuits to increase or decrease available bandwidth between packet interface functions engaging the circuit switched transport network.

15. The method of claim 14 further comprising:
configuring the packet interface functions between a Local Area Network (LAN) and the circuit switched transport network, to interface a framing and mapping function, a virtual concatenation function, and a circuit set-up/tear-down function for an automatic control plane; and
controlling a capacity adjustment function via the virtual concatenation function to create or remove the virtual concatenation circuits responsive to receiving requests from a traffic estimator at the circuit set-up/tear-down function.

16. The method of claim 14 wherein the estimated amount of packet data traffic is based on a traffic measurement.

17. The method of claim 14 wherein the estimated amount of packet data traffic is based on advance estimated bandwidth necessity requests for packet traffic.

18. The method of claim 15 wherein the circuit set-up/tear-down function for the automatic control plane comprises an Automatic Switched Transport Network (ASTN).

19. The method of claim 15 wherein the capability adjustment function comprises a Link Capacity Adjustment Scheme (LCAS) function.

20. The method of claim 15 wherein the virtual concatenation function comprises a Virtual Concatenation (VCAT) function.

21. The method of claim 15 wherein the framing and mapping function comprises a Generic Framing Procedure (GFP) function.

22. The method of claim 15 wherein the framing and mapping function comprises a Packet over SONET (POS) function with Point-to-Point Protocol/High-level Data Link Control (PPP/HDLC).

23. The method of claim 14 wherein the circuit switched transport network comprises a Synchronous Digital Hierarchy (SDH) network.

24. The method of claim 14 wherein the circuit switched transport network comprises a Synchronous Optical Network (SONET).

25. The method of claim 14 wherein the circuit switched transport network comprises a Optical Transport Network (OTN).

26. A packet data network having routers and/or switches that are interconnected by a circuit switched transport network, the packet data network comprising:
a traffic estimator function configured to estimate an amount of packet data traffic; and
a capacity adjustment function configured to create or remove virtual concatenation circuits to increase or decrease available bandwidth between packet interface functions engaging the circuit switched transport network.

27. The network of claim 26 wherein the packet interface functions are configured between a Local Area Network (LAN) and the circuit switched transport network, to interface a framing and mapping function, a virtual concatenation function, and a circuit set-up/tear-down function for an automatic control plane, and wherein the circuit set-up/tear-down function is configured to control the capacity adjustment function via the virtual concatenation function responsive to receiving requests from the traffic estimator.

28. The network of claim 26 wherein the traffic estimator is configured to estimate the amount of packet data traffic based on a traffic measurement.

29. The network of claim 26 wherein the traffic estimator is configured to estimate the amount of packet data traffic based on advance estimated bandwidth necessity requests for packet data traffic.

30. The network of claim 27 wherein the circuit set-up/tear-down function for the automatic control plane comprises an Automatic Switched Transport Network (ASTN).

31. The network of claim 26 wherein the capability adjustment function comprises a Link Capacity Adjustment Scheme (LCAS) function.

32. The network of claim 27 wherein the virtual concatenation function comprises a Virtual Concatenation (VCAT) function.

33. The network of claim 27 wherein the framing and mapping function comprises a Generic Framing Procedure (GFP) function.

34. The network of claim 27 wherein the framing and mapping function comprises a Packet over SONET (POS) function with Point-to-Point Protocol/High-level Data Link Control (PPP/HDLC).

35. The network of claim 26 wherein the circuit switched transport network comprises a Synchronous Digital Hierarchy (SDH) network.

36. The network of claim 26 wherein the circuit switched transport network comprises a Synchronous Optical Network (SONET).

37. The network of claim 26 wherein the circuit switched transport network comprises a Optical Transport Network (OTN).
